(19) United States
(12) Patent Application Publication
(10) Pub. No.: US 2026/0165341 A1
(43) Pub. Date: Jun. 18, 2026

(54) MAKING APPARATUS WITH SEALING CONNECTION COMPONENT AND COLD BEVERAGE MAKER

(71) Applicant: Guangdong Welly Electrical Appliances Co., Ltd., Zhongshan (CN)

(72) Inventors: Xiangan Wu, Zhongshan (CN); Linjun Mai, Zhongshan (CN); Yangyang Ma, Zhongshan (CN); Wenzhan Hu, Zhongshan (CN)

(21) Appl. No.: 19/079,479

(22) Filed: Mar. 14, 2025

(30) Foreign Application Priority Data
Dec. 13, 2024 (CN) 202423089608.4

(51) Int. Cl. A23G 9/22; A23G 9/12; B01F 35/30; B01F 35/33; B01F 101/13

(52) U.S. Cl. CPC A23G 9/224; A23G 9/12; B01F 35/33; B01F 2035/351; B01F 2101/13

(57) ABSTRACT

The present disclosure relates to a making apparatus with sealing connection component and a cold beverage maker. The making apparatus with sealing connection component includes an insulating housing, a making cartridge, and a first sealing connection seat, where a first mounting hole is formed in a sidewall of the insulating housing; a second mounting hole is formed in the making cartridge; a rotating shaft rotatably penetrates through the second mounting hole and the first mounting hole; the first sealing connection seat is connected to a limiting member; the limiting member is inserted into the second mounting hole; and the limiting member is in sealing connection with the second mounting hole. The present disclosure can prolong the service life of the making apparatus, effectively lowers the leakage risk of the liquid water in the making cartridge, and ensures an ice-making rate of the liquid water of the cold beverage maker.

### CROSS REFERENCE TO RELATED APPLICATIONS

The present application claims the benefit of Chinese Patent Application No. 2024230896084 filed on Dec. 13, 2024, the contents of which are incorporated herein by reference in their entirety.

### TECHNICAL FIELD

The present disclosure relates to the technical field of refrigeration devices, and in particular to a making apparatus with sealing connection component and a cold beverage maker.

### BACKGROUND

As an efficient, convenient and multifunctional device for making cold beverages, the cold beverage maker has been widely applied to various dining places or home kitchens. The existing cold beverage maker mainly includes a refrigeration system and a stirring system. When the cold beverage maker works, the refrigeration system is configured to convey a cooled refrigerant to an evaporator in a making cartridge of the stirring system. The refrigerant exchanges heat with liquid water in the making cartridge, and the liquid water is made into ice chunks or iced beverages containing the ice chunks. The stirring system is then configured to convey the ice chunks to the outside of the making cartridge for use.

In order to prevent leakage of the liquid water, a sealing apparatus is provided between the rotating shaft of the stirring system and the making cartridge. However, in actual work of the cold beverage maker, due to continuous rotation and friction of the rotating shaft, the sealing apparatus is worn gradually to affect sealing performance. Consequently, the liquid water in the making cartridge has a leakage risk to affect an ice-making rate of the cold beverage maker.

### SUMMARY

In view of the defect in the prior art, the present disclosure provides a making apparatus with sealing connection component and a cold beverage maker. The present disclosure can prolong the service life of the making apparatus, effectively lowers the leakage risk of the liquid water in the making cartridge, and ensures an ice-making rate of the liquid water of the cold beverage maker.

In order to solve the above technical problem, the present disclosure provides a making apparatus with sealing connection component, including:
an insulating housing, a first mounting hole being formed in a sidewall of the insulating housing;
a making cartridge mounted in the insulating housing, a second mounting hole being formed in the making cartridge, and a rotating shaft rotatably penetrating through the second mounting hole and the first mounting hole; and
a first sealing connection seat connected between the insulating housing and the making cartridge, the first sealing connection seat being connected to a limiting member, the limiting member being inserted into the second mounting hole, and the limiting member being in sealing connection with the second mounting hole, where
the rotating shaft penetrates through the limiting member; a first sealing member is provided between the rotating shaft and the limiting member; and the first sealing member includes an inner ring in sealing connection with the rotating shaft, and an outer ring in clearance fit with the limiting member.

As an improvement to the above solution, an end of the limiting member inserted into the second mounting hole is provided with an extended boss; and the extended boss includes an outer ring abutting against an inner sidewall of the making cartridge through a sealing gasket in a sealing manner, and an inner ring connected to the outer ring of the first sealing member.

As an improvement to the above solution, a side of the first sealing member away from the making cartridge is provided with a second sealing member; and an inner ring of the second sealing member is in sealing connection with the rotating shaft.

As an improvement to the above solution, the first sealing connection seat has a preset height; and a distance between an inner side of the insulating housing and an outer side of the making cartridge is the same as the preset height.

As an improvement to the above solution, the making apparatus with sealing connection component further includes:
a second sealing connection seat provided on an outer sidewall of the insulating housing; the second sealing connection seat is detachably connected to the first sealing connection seat; and a size of the second sealing connection seat is greater than a size of the first mounting hole.

As an improvement to the above solution, a side of the second sealing connection seat close to the first sealing connection seat is provided with a sealing boss; an insertion hole is formed in the first sealing connection seat; the sealing boss is inserted into the insertion hole; and an inner side of the sealing boss abuts against the second sealing member.

As an improvement to the above solution, a first mounting groove is formed in the outer sidewall of the insulating housing; and the second sealing connection seat is embedded into the first mounting groove.

As an improvement to the above solution, the making apparatus with sealing connection component further includes:
a driving connection seat; the driving connection seat includes one side connected to the second sealing connection seat, and the other side connected to a driving member; a transmission set is provided in the driving connection seat; an output shaft of the driving member is rotatably connected to a driving end of the transmission set; and a driven end of the transmission set is rotatably connected to the rotating shaft.

As an improvement to the above solution, a second mounting groove is formed at a side of the second sealing connection seat away from the insulating housing; and one side of the driving connection seat is embedded into the second mounting groove.

Accordingly, the present disclosure further provides a cold beverage maker, including the above making apparatus with sealing connection component, where the cold beverage maker is a smoothie maker or an ice cream maker or a multifunctional machine for making smoothie and ice cream.

The present disclosure has the following beneficial effects:

According to the making apparatus with sealing connection component provided by the embodiment, a sealing apparatus including the first sealing connection seat, the limiting member, and the first sealing member is assembled between the rotating shaft and the making cartridge. This can effectively ensure assembly stability of the sealing apparatus. Because of the clearance fit between the outer ring of the first sealing member and the limiting member, in rotation of the rotating shaft, the rotating shaft can be in movable sealing connection with the first sealing connection seat and the limiting member through the first sealing member. This reduces the wear extent to the first sealing member for wear of the rotating shaft, prolongs the service life of the first sealing member, and ensures sealing performance between the rotating shaft and the first sealing connection seat, thereby effectively lowering a leakage risk of the liquid water of the making cartridge, and ensuring an ice-making rate of the liquid water of the cold beverage maker.

### BRIEF DESCRIPTION OF THE DRAWINGS

FIG. 1 is a schematic perspective view of a making apparatus with sealing connection component according to an embodiment of the present disclosure;

FIG. 2 is a schematic exploded view of a making apparatus with sealing connection component according to an embodiment of the present disclosure;

FIG. 3 is a schematic view of connection between a first sealing connection seat and a second sealing connection seat according to an embodiment of the present disclosure;

FIG. 4 is a schematic sectional view of a making apparatus with sealing connection component according to an embodiment of the present disclosure;

FIG. 5 is an enlarged view of A shown in FIG. 4; and

FIG. 6 is a schematic perspective view of an insulating housing according to an embodiment of the present disclosure.

### DETAILED DESCRIPTION

In order to make the objectives, technical solutions, and advantages of the present disclosure clearer, the present disclosure will be further described in detail with reference to the accompanying drawings. It should be noted that orientation terms such as “upper”, “lower”, “left”, “right”, “front”, “rear”, “inner”, and “outer” that appear or are about to appear in the present disclosure are only based on the accompanying drawings of the present disclosure, and do not specifically limit the present disclosure.

The present disclosure provides a making apparatus with sealing connection component, which can prolong the service life of the making apparatus, effectively lowers the leakage risk of the liquid water in the making cartridge 2, and ensures an ice-making rate of the liquid water of the cold beverage maker.

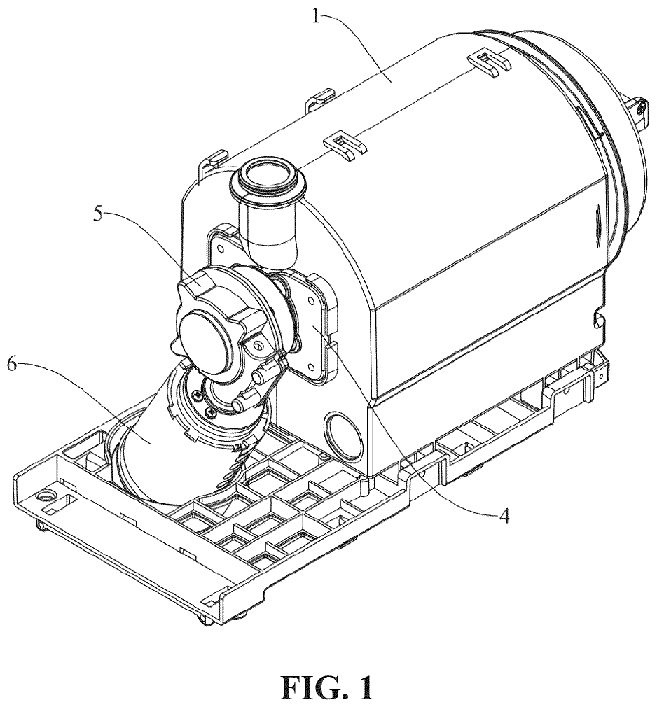

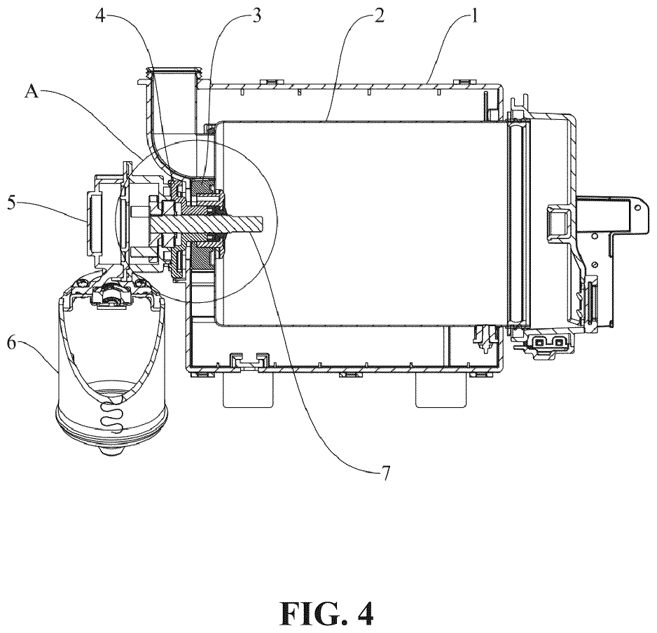

In a specific embodiment of the present disclosure, as shown in FIG. 1 to FIG. 6, the making apparatus with sealing connection component includes an insulating housing 1, a making cartridge 2, and a first sealing connection seat 3. A first mounting hole 11 is formed in a sidewall of the insulating housing 1. The making cartridge 2 is mounted in the insulating housing 1. A second mounting hole 21 is formed in the making cartridge 2. A rotating shaft 7 rotatably penetrates through the second mounting hole 21 and the first mounting hole 11. The first sealing connection seat 3 is connected between the insulating housing 1 and the making cartridge 2. The first sealing connection seat 3 is connected to a limiting member 31. The limiting member 31 is inserted into the second mounting hole 21. The limiting member 31 is in sealing connection with the second mounting hole 21. The rotating shaft 7 penetrates through the limiting member 31. A first sealing member 32 is provided between the rotating shaft 7 and the limiting member 31. The first sealing member 32 includes an inner ring in sealing connection with the rotating shaft 7, and an outer ring in clearance fit with the limiting member 31.

According to the making apparatus with sealing connection component provided by the embodiment, a sealing apparatus including the first sealing connection seat 3, the limiting member 31, and the first sealing member 32 is assembled between the rotating shaft 7 and the making cartridge 2. This can effectively ensure assembly stability of the sealing apparatus. Because of the clearance fit between the outer ring of the first sealing member 32 and the limiting member 31, in rotation of the rotating shaft 7, the rotating shaft 7 can be in movable sealing connection with the first sealing connection seat 3 and the limiting member 31 through the first sealing member 32. This reduces the wear extent to the first sealing member 32 for wear of the rotating shaft 7, prolongs the service life of the first sealing member 32, and ensures sealing performance between the rotating shaft 7 and the first sealing connection seat 3, thereby effectively lowering a leakage risk of the liquid water of the making cartridge 2, and ensuring an ice-making rate of the liquid water of the cold beverage maker.

It is to be noted that the first sealing member 32 is preferably made of a wear-resistant and corrosion-resistant material such as polytetrafluoroethylene (PTFE) or rubber to prevent wear or corrosion of the first sealing member 32 in longtime use.

In the embodiment, the first sealing connection seat 3 can be limited in the second mounting hole 21 of the making cartridge 2 through the limiting member 31, and sealing performance between the first sealing connection seat 3 and the making cartridge 2 is ensured with sealing connection between the limiting member 31 and a sidewall of the second mounting hole 21.

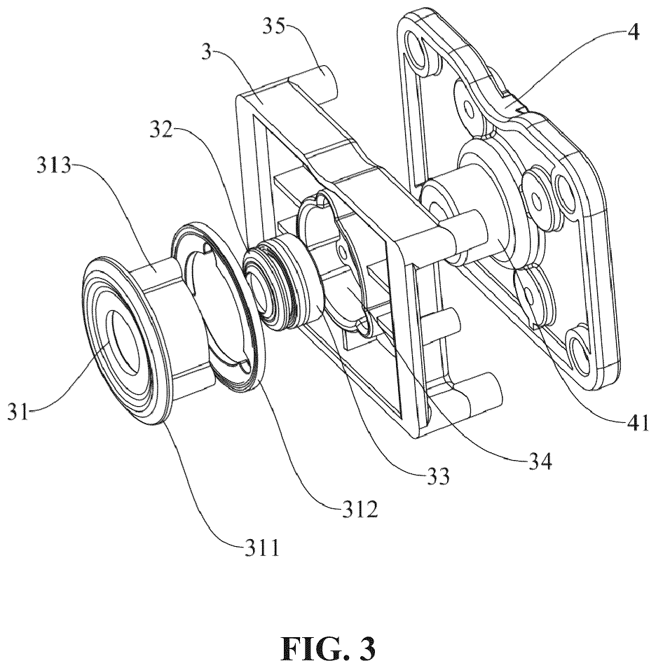

Specifically, in order to ensure sealing fit between the limiting member 31 and the second mounting hole 21, as shown in FIG. 3 to FIG. 5, an end of the limiting member 31 inserted into the second mounting hole 21 is provided with an extended boss 311. The extended boss 311 includes an outer ring abutting against an inner sidewall of the making cartridge 2 through a sealing gasket 312 in a sealing manner, and an inner ring connected to the outer ring of the first sealing member 32, so as to ensure that the first sealing member 32 is limited in the rotating shaft 7 through the limiting member 31. The sealing gasket 312 can cause deformation under a pressure to adaptively fill up a gap between connecting surfaces. The sealing gasket 312 is used to adapt to an abutment gap between the extended boss 311 of the limiting member 31 and the inner sidewall of the making cartridge 2 to realize sealing contact between the limiting member 31 and the inner wall of the making cartridge 2. This prevents leakage of liquid in the making cartridge 2 from an abutment position between the limiting member 31 and the inner wall of the making cartridge 2, and further lowers the leakage risk of the liquid water in the making cartridge 2.

Optionally, the limiting member 31 is made of an elastic material such as rubber. After the limiting member 31 is inserted into the second mounting hole 21, a sidewall of the limiting member 31 is rebound and closely abuts against the sidewall of the second mounting hole 21 to further enhance sealing performance between the limiting member 31 and the making cartridge 2.

Certainly, the limiting member 31 is not limited to the elastic material such as the rubber, and may also be made of a hard material. When the limiting member 31 is made of the hard material, the limiting member 31 is detachably connected to the first sealing connection seat 3 to ensure ease of assembly between the limiting member 31 and the first sealing connection seat 3.

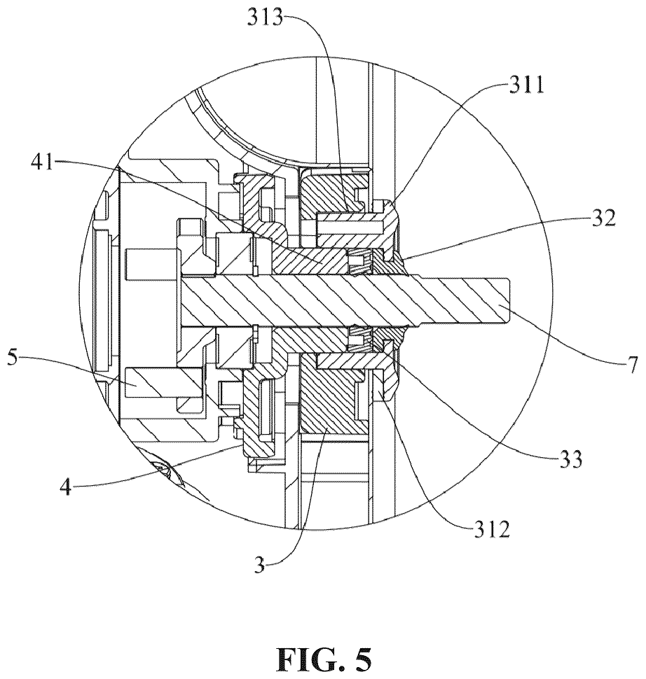

Specifically, as shown in FIG. 3 and FIG. 5, the limiting member 31 is provided with a connecting post 313. A plurality of threaded holes are formed in the connecting post 313 at intervals. A plurality of connecting holes are formed in the first sealing connection seat 3. When the first sealing connection seat 3 and the limiting member 31 are assembled to the making cartridge 2, the connecting post 313 of the limiting member 31 may penetrate through the second mounting hole 21, and the first sealing connection seat 3 and the limiting member 31 are connected through a bolt or a stud, thereby ensuring ease of assembly between the limiting member 31 and the first sealing connection seat 3.

Further, a side of the first sealing member 32 away from the making cartridge 2 is provided with a second sealing member 33. The second sealing member 33 includes an inner ring in sealing connection with the rotating shaft 7, and an outer ring abutting against the limiting member 31. The second sealing member 33 is used to further reduce the connecting gap between the limiting member 31 and the rotating shaft 7, thereby further enhancing sealing performance between the rotating shaft 7 and the limiting member 31.

Specifically, the inner ring of the second sealing member 33 is provided with a seal lip. A section of the seal lip is an oblique plane. Through the second sealing member 33, an oil seal is formed between the rotating shaft 7 and the limiting member 31 as well as between the rotating shaft and the first sealing connection seat 3. Through cooperation between the second sealing member 33 and the first sealing member 32, stable and reliable sealing performance is provided for the rotating shaft 7, the limiting member 31 and the first sealing connection seat 3.

In the embodiment, in order to ensure mounting stability of the first sealing connection seat 3, the first sealing connection seat 3 has a preset height. A distance between an inner side of the insulating housing 1 and an outer side of the making cartridge 2 is the same as the preset height. When the first sealing connection seat 3 is assembled between the insulating housing 1 and the making cartridge 2, the first sealing connection seat 3 can be clamped by the inner side of the insulating housing 1 and the outer wall of the making cartridge 2, and the first sealing connection seat 3 is connected by the limiting member 31 penetrating through the second mounting hole 21. This ensures assembly stability of the first sealing connection seat 3 between the insulating housing 1 and the making cartridge 2, and prevents the first sealing connection seat 3 from shaking to affect the sealing performance of the first sealing member 32.

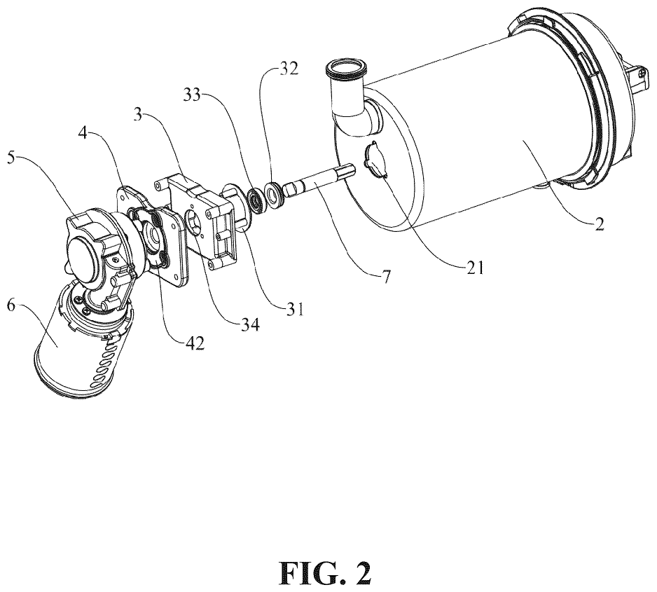

In the embodiment, as shown in FIG. 2 to FIG. 5, the making apparatus with sealing connection component further includes a second sealing connection seat 4. The second sealing connection seat 4 is provided on an outer sidewall of the insulating housing 1. The second sealing connection seat 4 is detachably connected to the first sealing connection seat 3. A size of the second sealing connection seat 4 is greater than a size of the first mounting hole 11. When the second sealing connection seat 4 is connected to the outer sidewall of the insulating housing 1, the second sealing connection seat 4 can shield the first mounting hole 11 to prevent an internal component of the insulating housing 1 from being exposed, and realize dust prevention for the insulating housing 1.

It is to be noted that in order to detachably connect the first sealing connection seat 3 and the second sealing connection seat 4, and connect the first sealing connection seat 3 and the second sealing connection seat 4 to form the whole sealing apparatus, a side of the first sealing connection seat 3 away from the making cartridge 2 is provided with a connecting boss 35, and a connecting hole is formed in the second sealing connection seat 4. When the first sealing connection seat 3 and the second sealing connection seat 4 are assembled, the connecting boss 35 of the first sealing connection seat 3 penetrates through a mounting hole in a sidewall of the insulating housing 1, and the first sealing connection seat 3 and the second sealing connection seat 4 are threadedly connected with a bolt or a stud.

Further, as shown in FIG. 3 to FIG. 5, a side of the second sealing connection seat 4 close to the first sealing connection seat 3 is provided with a sealing boss 41. An insertion hole 34 is formed in the first sealing connection seat 3. The sealing boss 41 is inserted into the insertion hole 34. An inner side of the sealing boss 41 abuts against the second sealing member 33. With sealing contact between the inner side of the sealing boss 41 and the second sealing member 33, sealing connection is formed at a junction between the first sealing connection seat 3 and the second sealing connection seat 4, and the second sealing member 33 is limited axially. This further ensures sealing performance of the second sealing member 33 for the first sealing connection seat 3 and the second sealing connection seat 4.

It is to be noted that in the embodiment, the insertion hole 34 is coaxial with the first mounting hole 11 and the second mounting hole 21. A hollow hole is formed in the sealing boss 41. The rotating shaft 7 is rotatably connected to the hollow hole. The sealing boss 41 of the second sealing connection seat 4 is used to limit and protect the rotating shaft 7 to further ensure rotational stability of the rotating shaft 7.

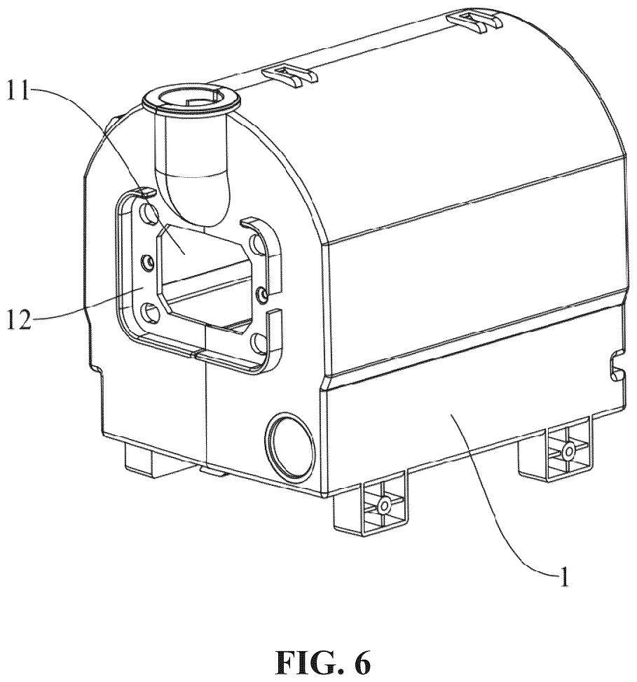

As shown in FIG. 6, a first mounting groove 12 is formed in the outer sidewall of the insulating housing 1. The second sealing connection seat 4 is embedded into the first mounting groove 12. The outer sidewall of the second sealing connection seat 4 is limited and fixed by the first mounting groove 12 to further ensure stability of the second sealing connection seat 4 on the insulating housing 1.

In the specific embodiment of the present disclosure, as shown in FIG. 1 and FIG. 2, the making apparatus with sealing connection component further includes a driving connection seat 5. The driving connection seat 5 includes one side connected to the second sealing connection seat 4, and the other side connected to a driving member 6. A transmission set (not shown in the figure) is provided in the driving connection seat 5. An output shaft of the driving member 6 is rotatably connected to a driving end of the transmission set. A driven end of the transmission set is rotatably connected to the rotating shaft 7. The driving member 6 can drive the driving end of the transmission set to rotate, thereby driving the driven end of the transmission set and the rotating shaft 7 to rotate. Therefore, the rotating shaft 7 can drive a stirring structure in the making cartridge 2 to rotate, thereby realizing transmission of ice chunks in the making cartridge 2.

With dust prevention of the driving connection seat 5 for the transmission set as well as a junction between the transmission set and the driving member 6, and a junction between the transmission set and the rotating shaft 7, the driving member 6, the transmission set and the rotating shaft 7 cannot be directly exposed out in an external environment to ensure effective transmission among the driving member 6, the transmission set and the rotating shaft 7, and ensure a rate of energy utilization of the driving member 6.

It is to be noted that the driving connection seat 5 may include a first connection seat and a second connection seat that are detachably connected, so as to facilitate maintenance and repair of the transmission set in the driving connection seat 5. The first connection seat is connected to a housing of a drive motor, and the second connection seat is connected to the second sealing connection seat 4. A front end of the rotating shaft 7 is rotatably connected to the second connection seat through a bearing to further ensure rotational stability of the rotating shaft 7.

It is further to be noted that the transmission set is preferably a gear set for transmission of the driving member 6 and the rotating shaft 7 to reduce a space occupied by the driving connection seat 5, and improve space utilization of the making apparatus with sealing connection component. Certainly, the specific structure of the transmission set is not limited to the gear set, and may also be other transmission structures such as a chain transmission structure or a belt transmission structure. The specific structure of the transmission set may be set corresponding according to an actual condition.

As shown in FIG. 2, a second mounting groove 42 is formed at a side of the second sealing connection seat 4 away from the insulating housing 1. One side of the driving connection seat 5 is embedded into the second mounting groove 42. The side of the second sealing connection seat 4 is limited and fixed by the second mounting groove 42 to ensure connection stability between the second sealing connection seat 4 and the driving connection seat 5.

It is to be noted that in order to further ensure connection stability between the driving connection seat 5 and the second sealing connection seat 4, a plurality of threaded countersinks are formed in the second mounting groove 42. A plurality of threaded holes are formed in the driving connection seat 5. When the side of the driving connection seat 5 is embedded into the second mounting groove 42, the threaded hole and the threaded countersink matching correspondingly are threadedly connected through a bolt or a stud to further improve the connection stability between the driving connection seat 5 and the second sealing connection seat 4.

Accordingly, the present disclosure further provides a cold beverage maker, including the making apparatus with sealing connection component in any of the above embodiments. The cold beverage maker is a smoothie maker or an ice cream maker or a multifunctional machine for making smoothie and ice cream. The cold beverage maker provided by the embodiment can prolong the service life of the making apparatus, effectively lowers the leakage risk of the liquid water in the making cartridge 2, and ensures an ice-making rate of the liquid water of the cold beverage maker. The cold beverage maker has all of the beneficial effects of the making apparatus with sealing connection component, which is not repeated herein.

It is to be noted that a loading plate is provided in the cold beverage maker. The insulating housing 1 and the driving member 6 are assembled in the loading plate to mount and fix the making apparatus with sealing connection component in the cold beverage maker.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. A making apparatus with sealing connection component, comprising:
an insulating housing, a first mounting hole being formed in a sidewall of the insulating housing;
a making cartridge mounted in the insulating housing, a second mounting hole being formed in the making cartridge, and a rotating shaft rotatably penetrating through the second mounting hole and the first mounting hole; and
a first sealing connection seat connected between the insulating housing and the making cartridge, the first sealing connection seat being connected to a limiting member, the limiting member being inserted into the second mounting hole, and the limiting member being in sealing connection with the second mounting hole, wherein
the rotating shaft penetrates through the limiting member; a first sealing member is provided between the rotating shaft and the limiting member; and the first sealing member comprises an inner ring in sealing connection with the rotating shaft, and an outer ring in clearance fit with the limiting member.

2. The making apparatus with sealing connection component according to claim 1, wherein an end of the limiting member inserted into the second mounting hole is provided with an extended boss; and the extended boss comprises an outer ring abutting against an inner sidewall of the making cartridge through a sealing gasket in a sealing manner, and an inner ring connected to the outer ring of the first sealing member.

3. The making apparatus with sealing connection component according to claim 1, wherein a side of the first sealing member away from the making cartridge is provided with a second sealing member; and an inner ring of the second sealing member is in sealing connection with the rotating shaft.

4. The making apparatus with sealing connection component according to claim 1, wherein the first sealing connection seat has a preset height; and a distance between an inner side of the insulating housing and an outer side of the making cartridge is the same as the preset height.

5. The making apparatus with sealing connection component according to claim 3, further comprising:
a second sealing connection seat provided on an outer sidewall of the insulating housing, wherein the second sealing connection seat is detachably connected to the first sealing connection seat; and a size of the second sealing connection seat is greater than a size of the first mounting hole.

6. The making apparatus with sealing connection component according to claim 5, wherein a side of the second sealing connection seat close to the first sealing connection seat is provided with a sealing boss; an insertion hole is formed in the first sealing connection seat; the sealing boss is inserted into the insertion hole; and an inner side of the sealing boss abuts against the second sealing member.

7. The making apparatus with sealing connection component according to claim 5, wherein a first mounting groove is formed in the outer sidewall of the insulating housing; and the second sealing connection seat is embedded into the first mounting groove.

8. The making apparatus with sealing connection component according to claim 5, further comprising:
a driving connection seat, wherein the driving connection seat comprises one side connected to the second sealing connection seat, and the other side connected to a driving member; a transmission set is provided in the driving connection seat; an output shaft of the driving member is rotatably connected to a driving end of the transmission set; and a driven end of the transmission set is rotatably connected to the rotating shaft.

9. The making apparatus with sealing connection component according to claim 8, wherein a second mounting groove is formed at a side of the second sealing connection seat away from the insulating housing; and one side of the driving connection seat is embedded into the second mounting groove.

10. A cold beverage maker, comprising the making apparatus with sealing connection component according to claim 1, wherein the cold beverage maker is a smoothie maker or an ice cream maker or a multifunctional machine for making smoothie and ice cream.
